(19) United States
(12) Patent Application Publication
(10) Pub. No.: US 2005/0174414 A1
(43) Pub. Date: Aug. 11, 2005

(54) Ink jet recording medium

(76) Inventors: Yoshio Yoshida, Tokyo (JP); Shoichi Endo, Tokyo (JP); Kazuhiro Iwasaki, Tokyo (JP); Jiro Yoshimura, Tokyo (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/509,013

(22) PCT Filed: Mar. 27, 2003
(86) PCT No.: PCT/JP03/03870

(30) Foreign Application Priority Data
Mar. 28, 2002 (JP) 2002-093328

(51) Int. Cl. B41J 2/01

(52) U.S. Cl. 347/105

(57) ABSTRACT

This invention is an inkjet recording medium formed by providing a recording layer comprising γ-alumina having an average particle diameter of 8 μm or less as pigment, and a urethane resin having a glass transition temperature of 10° C.-50° C. together with polyvinyl alcohol as a binder, on a support having air permeability. The surface image clarity of the recording layer is 20% or more. The recording layer can be provided by the cast coating method.

### FIELD OF THE INVENTION

This invention relates to an inkjet recording medium, and in particular to an inkjet recording cast-coated paper which is suitable for printing not only with dye inks but also pigment inks, which is excellent for continuous operation during manufacture, and which gives a gloss comparable to that of a silver halide photograph.

### BACKGROUND OF THE INVENTION

In general, in inkjet recording methods, recording is performed by spraying ink droplets from various devices, and the droplets adhere to a recording paper so as to form dots. The advantages of inkjet recording as compared to dot impact printing are that it is noiseless, it is easy to adapt to full color, and high-speed printing can be performed. On the other hand, ink jet recording has the disadvantage that, as the inks used are normally water-based inks which use direct dyes or acidic dyes, drying properties are poor.

Recently, due to the popularity of high-resolution digital video decks, digital cameras, scanners and personal computers, there are more opportunities to handle fine detail images, and to output these images to an inkjet printer. This has given rise to various demands for inkjet recording media, and an increasing demand for a recording medium which offers the gloss of a silver halide photograph.

The properties required of the inkjet recording sheet used in this inkjet recording method include the following:
(1) ink drying speed is rapid,
(2) print density is high,
(3) there is no ink smudging or blurring,
(4) there is no waving Of the paper due to ink absorption.

A method for manufacturing a high-quality inkjet recording paper satisfying these properties by the cast coating method has already been disclosed (JP-A S62-95285, S63-264391, H2-274587, H5-59694).

In all of these manufacturing methods, a recording layer is formed by coating a pigment having synthetic silica as its principal component together with a binder, and pressing the coated layer before drying (while it is still wet) in contact with a heated mirror surface so as to transfer and simultaneously dry the mirror surface, and thus obtain a high gloss cast-coated paper. However, the gloss of the uppermost layer was still low, and the gloss of a silver halide photograph could not be obtained.

A method of manufacturing an ink jet recording paper having the gloss of a silver halide photograph, wherein a recording layer containing a hydrophilic binder such as polyvinyl alcohol or gelatin and inorganic particulates is coated on a resin-coated paper (“RC paper”) having a resin coating layer to which a white pigment or the like has been added on at least one side of a base paper, has also been proposed (JP-A H10-119423, H11-20306). These inkjet recording papers use a resin coating paper with no air permeability as a support, and as water vapor could not escape from the coated layer side through the base paper to the non-coated side to allow the paper to dry, productivity was extremely low.

Moreover, a recording paper using a compound containing an alumina hydrate generally referred to as an alumina sol has been proposed for example in JP-A H5-124330, H6-79967 and H11-91238. However, the stability of the coating solution containing the alumina hydrate was poor, and productivity was low.

It is therefore an object of this invention to provide an inkjet recording cast-coated paper having a gloss similar to that of a silver halide photograph, which offers good inkjet recording properties and good productivity.

### SUMMARY OF THE INVENTION

The Inventors discovered that by treating a recording layer surface containing alumina having a specific crystalline form and particle diameter as pigment, and an urethane resin emulsion and polyvinyl alcohol as binder, with a solution having the function of solidifying the polyvinyl alcohol, and bringing it into pressure contact with the heated mirror surface of a drum via a press roll, an inkjet recording cast-coated paper having good ink jet recording properties and a gloss comparable to that of a silver halide photograph, was obtained with high yield.

This invention is therefore an inkjet recording medium comprising a recording layer formed by coating a coating solution containing alumina, resin emulsion and polyvinyl alcohol. The alumina is y-alumina having an average particle diameter of 8 μm or less, the resin emulsion is a urethane resin emulsion having a glass transition temperature of 10° C.-50° C., and the image clarity of the recording layer is 20% or more.

According to this invention, the urethane resin emulsion is preferably a polyester type cationic resin emulsion, and the average particle diameter of the y-alumina is preferably 1.0 μm-4.0 μm.

Further, the recording layer in this invention is preferably a glossy recording layer formed by coating the treatment solution, which has the property of solidifying the polyvinyl alcohol in the coating layer, on the coating layer after coating while it is still wet, and bringing this layer into pressure contact with the heated mirror surface of a drum, and drying.

### DESCRIPTION OF THE PREFERRED EMBODIMENTS

(Support)

The support used in this invention is not particularly limited provided that it is permeable, but paper (coated paper or uncoated paper) is preferably used. The raw material pulp for this paper may be a chemical pulp (bleached or unbleached craft pulp from coniferous trees, bleached or unbleached craft pulp from deciduous trees), mechanical pulp (groundwood pulp, thermomechanical pulp, chemithermomechanical pulp or deinked pulp), any of which may be used alone, or blended together in a desired ratio. The pH of the paper may be acid, neutral or alkaline. The opacity of the paper is preferably increased by containing a filler in the paper. This filler may be suitably selected from among those known in the art such as hydrated silicic acid, white carbon, talc, kaolin, clay, calcium carbonate, titanium oxide or a synthetic resin.

(Pigment)

The γ-alumina used for the recording layer in this invention is obtained by heating pseudo-boehmite or boehmite, manufactured by the method known in the art, to a temperature of 400° C.-900° C. The γ-alumina manufactured in this way is crushed and classified to adjust it to a desired particle diameter and particle size distribution range.

As the γ-alumina is in the form of thin scales, there is a strong adhesion between the coated layer containing the alumina and the heated mirror surface drum, so it might be supposed that duplication of the mirror surface of the drum would be easily accomplished. Also, the γ-alumina is transparent, so it might be supposed that color can be easily developed when the ink jet recording is performed. Further, it might also be supposed that if an alumina having a crystal structure other than the γ-type is used, the contact between the coated layer and the cast drum would be insufficient, and it would be more difficult to duplicate the mirror surface of the drum on the coated layer surface.

The average particle diameter of the y-type alumina used in this invention must be 8 μm or less, but it is preferably 11.0 μm-4.0 μm, and more preferably 2.0 μm-3.0 μm. If the average particle diameter exceeds 8 μm, the mirror surface of the heated drum cannot be adequately duplicated on the coated layer, and a recording medium having high gloss can no longer be obtained. On the other hand, if the average particle diameter is less than 1.0 μm, a recording medium having high gloss can be obtained, but ink absorption properties when recording is performed with an inkjet printer are poorer.

Also, the particle size distribution range of the y-alumina is preferably 0.4 μm-12.0 μm. If there are many particles less than 0.4 μm, gloss increases but ink absorption properties decrease. Alternatively, if particles exceeding 12.0 μm are included, the mirror surface of the heated drum cannot be adequately duplicated, so it is difficult to obtain a recording medium having high gloss. The aforesaid average particle diameter and particle size distribution range are measured by laser diffraction or scattering.

Further, from the viewpoint of improving coating suitability of the coating solution used for the recording layer, the specific surface area is preferably less than 200 m²/g, but more preferably less than 160 m²/g.

Another pigment such as α-alumina, θ-alumina, synthetic silica, kaolin, talc, calcium carbonate, titanium dioxide, clay or zinc oxide may be used together with aforesaid pigment provided that gloss is not impaired.

(Binder)

The recording layer in this invention contains a urethane resin together with polyvinyl alcohol as a binder.

The urethane resin emulsion forming the urethane resin may be obtained by reacting a polyol such as a diol or triol with an isocyanate such as a di-isocyanate, tri-isocyanate or tetra-isocyanate, or polyisocyanate.

This urethane resin emulsion may for example be a nonionic urethane resin emulsion obtained for example by reacting a di-isocyanate such as 1,6-hexane di-isocyanate, 1,4-butylene di-isocyanate, toluene di-isocyanate or xylene di-isocyanate with a polyol such as 3-butanediol, 1,4-butanediol, 1,6-hexanediol, polyethylene glycol, polypropylene glycol, polyester polyol or polycarbonate polyol, or a cationic urethane resin emulsion obtained by adding an alkanolamine containing N-methyldiethanolamine, or N-oleyldiethanolamine in the reaction between the isocyanate and polyol.

The urethane resin emulsion used in this invention must be a urethane resin emulsion having a glass transition temperature in the range of 10° C.-50° C. If the glass transition temperature is less than 10° C., although high gloss is obtained when cast coating is performed, part of the coated layer falls off and sticks to the mirror surface of the drum when the coated layer is pressed into contact with the heated mirror surface. On the other hand, if the glass transition temperature exceeds 50° C., the mirror surface of the drum is not adequately transferred, so gloss decreases and recording density when inkjet recording is performed is also poor. In this invention, the use of a polyester type urethane resin emulsion using a polyester polyol is preferable as it permits easy adjustment of the glass transition temperature.

The alumina used in this invention becomes cationic when dispersed in water, so from the viewpoint of miscibility, the use of a nonionic or cationic binder, and particularly a cationic binder, is preferred. From the viewpoint of miscibility with alumina, the cationic degree of the cationic urethane resin emulsion is preferably 0.6 meq/g or more. If the cationic degree is low, the recording layer coating solution becomes thicker and separates, so coating properties become poor. In particular, from the viewpoint of obtaining excellent color developing properties of the recorded image, 0.7 meq/g or more is preferred. However, if the cationic degree is too high, its function as a binding agent decreases, and operatability declines. As a result, the cationic degree is preferably 0.8 meq/g or less.

The urethane resin emulsion used in this invention preferably has a contact angle relative to water when in the form of a film, of 50° or less immediately after dripping in (0.1 second). If the contact angle is small, there is no loss of ink absorption properties in the inkjet recording medium.

The polyvinyl alcohol may be suitably selected regarding saponification degree and polymerization degree provided that it reacts sufficiently with the solidifying solution. In this invention, in addition to the aforesaid polyvinyl alcohol, and to the extent that it does not interfere with the effect of the invention, starches such as oxidized starch and esterified starch, cellulose derivatives such as carboxymethylcellulose and hydroxyethylcellulose, polyvinyl pyrrolidone, casein, gelatin, soya bean protein, styrene-acrylic resin and its derivatives, styrene-butadiene resin latex, acrylic resin emulsion, vinyl acetate resin emulsion, urethane resin emulsion, urea resin emulsion, alkyd resin emulsion and derivatives thereof may also be blended. Further, the blending amount of the resin component in the recording layer is preferably 5 wt parts-40 wt parts relative to 100 wt parts of pigment, but the aforesaid range is not limiting provided that the required coating layer strength is obtained. The polyvinyl alcohol and urethane resin emulsion (solids) in the recording layer are respectively preferably within the range of 2-30 wt parts relative to 100 wt parts of pigment. Within this range, both the gloss and ink absorption properties of the inkjet recording medium are excellent.

(Treatment Solution)

In this invention, the treatment solution having the function of solidifying the polyvinyl alcohol on the coating layer is preferably applied while the coating layer provided by coating the coating solution is still wet, and then this coating layer is pressed into contact with the heated mirror surface to impart gloss and produce a recording layer (glossy layer). If the coating layer is dry when the treatment solution is applied, is difficult to duplicate the mirror surface of the drum, and a large number of minute surface imperfections are formed which makes it difficult to obtain a gloss comparable to that of a silver halide photograph.

The treatment solution is not particularly limited provided that it is an aqueous solution containing a compound having the function of solidifying polyvinyl alcohol, but a treatment solution containing boric acid and a borate is preferred. By using a mixture of boric acid and a borate, it is easy to obtain a coating layer which is solidified to a suitable degree of hardness, and a cast coating paper for inkjet recording having a satisfactory gloss can be obtained. Also, by mixing a borate with boric acid, the solubility of the boric acid in water is enhanced compared to the case where boric acid is used alone, so the boric acid has a wider range of use, and consequently the solidification state of the polyvinyl alcohol can easily be adjusted.

It is particularly preferred that the blending ratio of borates and boric acid in the treatment solution is borate/boric acid=0.25/1−2/1. If the blending ratio of borate to boric acid is less than 0.25, the proportion of boric acid is too large and solidification of the polyvinyl alcohol in the coating layer is incomplete, so the partially solidified coating layer sticks to the solidifying solution supply roll and a satisfactory recording layer cannot be obtained. On the other hand, if the blending ratio of borate to boric acid exceeds 2, the polyvinyl alcohol in the recording layer solidifies too hard, so the gloss of the cast coating paper surface decreases and the gloss becomes uneven.

Examples of borates which can be used in this invention are borax, orthoborates, diborates, metaborates, pentaborates and octaborates, and in this invention, the borate may be suitably selected from among these. From the viewpoint of ease of procuring the material and low cost, the use of borax in this invention is particularly preferred.

The concentrations of borates and boric acid in the treatment solution may be suitably adjusted according to requirements. If the concentration of borates and boric acid in the treatment solution increases, the polyvinyl alcohol solidifies too hard, not only gloss deteriorates, but also crystals easily separate out from the treatment solution, and the stability of the treatment solution becomes poor.

(Image Clarity)

The image clarity in the recording layer surface of the inkjet recording paper of this invention must be 20% or more, and is preferably 25% or more. The gloss is better, the higher the image clarity is. The correlation between the impression of gloss as determined by human visual observation and mirror surface gloss is not clear. Therefore, in this invention, the evaluation was performed using an image clarity having the strongest correlation with visual evaluation. Image clarity is based on the JIS K7105, and can be measured by an image clarity tester.

(Release Agent)

A release agent may, if required, be added to the recording layer coating solution and treatment solution. The melting point of the added release agent is preferably 90-150° C., but more preferably 95-120° C. Within the above range, the melting point of the release agent is effectively identical to the metal surface temperature of the mirror finish, so the function of the release agent can be optimized. The release agent is not particularly limited provided that it has the aforesaid melting point. A particularly preferred release agent is polyethylene wax emulsion.

The coating solution or treatment solution which forms the recording layer in this invention may, if required, contain suitable additives such as a pigment dispersant, water retaining agent, thickener, antifoaming agent, preservative, colorant, water resistant additive, wetting agent, fluorescent dye, ultraviolet absorption agent and cationic polymer electrolyte.

The method used to coat the coating solution on the support may be suitably selected from among methods which use coating devices known in the art such as a blade coater, air knife coater, roll coater, brush coater, kiss coater, squeeze coater, curtain coater, dye coater, bar coater, gravure coater or comma coater.

The method of applying the treatment solution may be by means of a roll, spray or curtain, but this invention is not limited thereto. The coating amount of the recording layer may be adjusted as desired provided that it coats the side of the base paper and provides sufficient ink absorption properties, but from the viewpoint of both recording density and ink absorption properties, it is preferably 5-30 g/m² per side in terms of solids. If 30-g/m² is exceeded, release properties from the cast drum which has a mirror surface decline, and the coating layer may stick to the mirror surface of the drum. If a large coating amount is required, an underlayer is preferably provided between the support and the recording layer.

### EXAMPLES

This invention will now be described in more detail referring to specific examples and comparative examples, but it should be understood that the invention is not to be construed as being limited in any way thereby. Also, unless otherwise specified, “parts” and “%” respectively refer to “wt parts” and “wt %”.

### Example 1

A slurry was prepared by admixing 10 parts by weight of talc, 1.0 part by weight of aluminum sulfate, 0.1 parts by weight of a synthetic sizing agent and 0.02 parts by weight of a retention agent to 100 parts by weight of hardwood bleached broadleaf Kraft pulp(L-BKP) having a beating degree of 285 ml c.s.f. A support was made using a paper machine. Starch solution was coated on both side of the support to a dry coverage rate of 2.5 g/m² per side so as to obtain a base paper having a basis weight of 142 g/m². The following coating solution A was then coated using a blade coater on one side of this base paper to an amount of 8 g/m², and dried in a current of air at 140° C. Next, the following coating solution B was coated to an amount of 20 g/m² using a roll coater, on the side which had been coated with coating solution A, and the following solidifying solution C was applied while the coating layer was still wet to solidify the coating layer. Next, the coating layer was pressed in contact with a heated mirror surface via a press roll to duplicate the mirror surface on the surface of the coating layer, and an inkjet recording cast coating paper of 170 g/m² was thereby obtained.

Coating Solution A:

5 parts of latex (LX438C: commercial name, Sumitomo Chemical Industries Ltd.), 20 parts of polyvinyl alcohol (PVA-117: commercial name, Kuraray Co., Ltd.) and 5 parts of a sizing agent (Polymalon 360: commercial name, Arakawa Chemical Industries Ltd.) were blended with 100 parts of synthetic silica (Fineseal X-37: commercial name, Tokuyama corp.), so as to prepare an aqueous coating solution having a concentration of 20%.

Coating Solution B:

100 parts of γ-alumina having an average particle diameter of 2.4 μm and particle size distribution of 0.38-8.0 μm (AKP-GO15: commercial name, Sumitomo Chemical Industries Ltd.) as pigment, a total of 10 parts of polyvinyl alcohol A having a polymerization degree of 2,400 (Kuraray 224: commercial name, Kuraray Co., Ltd.) and polyvinyl alcohol B having a polymerization degree of 2,600 (MA26GP: commercial name, Shin-Etsu Chemical Co, Ltd.) in a ratio of 1:1 as binder, 5 parts of a cationic urethane resin emulsion having a glass transition temperature of 43° C. (F8570 D2: commercial name, Dai-Ichi Kogyo Seiyaku Ltd.), and 0.2 parts of an antifoaming agent were blended together so as to prepare a coating solution having a concentration of 28%.

Solidifying Solution C:

The solidifying solution was prepared by blending 4% Na₂B₄O₇ and H₃BO₃ in a ratio of borax/boric acid of 0.25, and 0.2% of a release agent (FL-48C: commercial name, Toho Chemical Industries Ltd.).

### Example 2

An inkjet recording cast coating paper was prepared in an identical way to that described in Example 1, except that instead of 100 parts of γ-alumina using the coating solution B of Example 1, 100 parts of γ-alumina having an average particle diameter of 3.3 μm and particle size distribution of 0.5-12.0 μm (AKP-G020: commercial name, Sumitomo Chemical Industries Ltd.) was used.

### Example 3

An inkjet recording cast coating paper was prepared in an identical way to that described in Example 1, except that 15 parts of cationic urethane resin emulsion (F8570 D2: Dai-Ichi Kogyo Seiyaku Ltd.) using the coating solution B of Example 1, were added.

### Example 4

An inkjet recording cast coating paper was prepared in an identical way to that described in Example 1, except that 30 parts of cationic urethane resin emulsion (F8570 D2: Dai-Ichi Kogyo Seiyaku Ltd.) using the coating solution B of Example 1, were added.

### Comparative Example 1

An inkjet recording cast coating paper was prepared in an identical way to that described in Example 1, except that instead of 100 parts of γ-alumina using the coating solution B of Example 1, 100 parts of γ-alumina having an average particle diameter of 9.0 μm and particle size distribution of 0.45-30 μm (AKP-G15: commercial name, Sumitomo Chemical Industries Ltd.) was used.

### Comparative Example 2

An inkjet recording cast coating paper was prepared in an identical way to that described in Example 1, except that instead of 100 parts of y-alumina using the coating solution B of Example 1, 100 parts of θ-alumina having an average particle diameter of 3.5 μm and particle size distribution of 0.4-13.5 μm (AKP-G008: commercial name, Sumitomo Chemical Industries Ltd.) was used.

### Comparative Example 3

An inkjet recording cast coating paper was prepared in an identical way to that described in Example 1, except that the cationic urethane resin emulsion (F8570 D2: Dai-Ichi Kogyo Seiyaku Ltd.) using the coating solution B of Example 1, was not blended.

### Comparative Example 4

An inkjet recording cast coating paper was prepared in an identical way to that described in Example 1, except that instead of 5 parts of the cationic urethane resin emulsion using the coating solution B of Example 1, 5 parts of a cationic urethane resin emulsion having a glass transition temperature of −18° C. (F8559D: commercial name, Dai-Ichi Kogyo Seiyaku Ltd.) was used.

### Comparative Example 5

An inkjet recording cast coating paper was prepared in an identical way to that described in Example 1, except that instead of 5 parts of the cationic urethane resin emulsion using the coating solution B of Example 1, 5 parts of a cationic urethane resin emulsion having a glass transition temperature of 70° C. (Super-Flex 600: commercial name, Dai-Ichi Kogyo Seiyaku Ltd.) was used.

### Comparative Example 6

An inkjet recording cast coating paper of 180 g/m² was obtained by coating the following coating solution D to the extent of 18 g/m² on the base paper obtained in Example 1, solidifying using the following solidifying solution E while the coating layer was still wet, and pressing in contact with a heated mirror surface via a press roll so as to duplicate the mirror surface.

Coating Solution D:

30 parts of an anionic urethane resin emulsion having a glass transition temperature of 6° C. (Super-Flex 700: commercial name, Dai-Ichi Kogyo Seiyaku Ltd.), 7 parts of casein solution, 2 parts of ammonia and 5 parts of a release agent (FL-48C: commercial name, Toho Chemical Industries Ltd.) were blended with 100 parts of synthetic silica (Fineseal X-37: commercial name, Tokuyama corp.) so as to prepare a 28% coating solution.

Coating Solution E:

5 parts of ammonium formate as solidifying agent, 5 parts of ink fixing agent (N123: commercial name, Senka Industries Ltd.) and 0.5 parts of a release agent (FL-48C: commercial name, Toho Chemical Industries Ltd.) were blended together so as to prepare a 10% aqueous solution.

The gloss, image clarity and inkjet recording test results for the inkjet recording papers obtained in Examples 1-4 and Comparative Examples 1-6 were summarized together with cast coating operatability during manufacture.

(1) Operatability

The soiling of the cast drum surface when coating was performed with a cast coater was visually evaluated as follows:
◯: No soiling of cast drum surface
Δ: Slight cloudiness of cast drum surface
X: Part of coating layer adheres to cast drum surface
   (2) Gloss

The gloss of the cast coating paper surface was visually evaluated as follows:
◯: Highly transparent gloss
Δ: Opaque gloss
X: Low gloss or coating unevenness
   (3) Image Clarity

This was measured using an image clarity tester (model: ICM-1DP, Suga Testing Instruments Ltd.) according to JIS K7105. The measurement angle was 45°, and the MD direction of the paper was measured.

(4) Inkjet Recording Test

A recording test was performed by recording a predetermined pattern using a dye ink inkjet printer (BJF900: commercial name, Canon Ltd.), and evaluated according to the following criteria:
a. Ink absorption properties (bleeding) The bleeding at the boundary of a red and green fill part was visually evaluated as follows:
◯: Color boundary was clearly demarcated
Δ: Slight bleeding at color boundary
X: Heavy bleeding at color boundary
   b. Clarity

The clarity of the recorded image was visually evaluated as follows:
◯: Clear
Δ: Slight loss of clarity
X: Not clearly visible
   (5) Glass Transition Temperature

The measurement of glass transition temperature was performed using a dynamic viscoelasticity measuring device (Rheolograph Solid: commercial name, Toyo Precision Instruments Ltd.),

(6) Cationic Degree

The cationic degree was measured using a cationic degree measuring device (METTLER TOLEDO TYPE DL50: commercial name, METTLER). The titration was performed using a 1/1,000 N aqueous solution of potassium polyvinyl sulfate.

(7) Contact Angle

The contact angle with respect to ion exchange distilled water (5 μl) after dripping for 0.1 seconds was measured using a contact angle meter (DAT1100: commercial name, Fibro Ltd.).

(TABLE 1)

| | | | Alumina | | | | |
|---|---|---|---|---|---|---|---|
| | Urethane | | | Average | Specific | | |
| | | Cationic | Crystal | particle | surface | | |
| | | degree | type | diameter | area | | |
| | Tg (° C.) | (meq/g) | (μm) | (μm) | (m²/g) | Operatability | Gloss |
| Example 1 | 43 | 0.77 | γ | 2.4 | 153 | ⊚ | ⊚ |
| Example 2 | 43 | 0.77 | γ | 3.3 | 230 | ◯ | ⊚ |
| Example 3 | 43 | 0.77 | γ | 2.4 | 153 | ⊚ | ⊚ |
| Example 4 | 43 | 0.77 | γ | 2.4 | 153 | ⊚ | ⊚ |
| Comp. Ex. 1 | 43 | 0.77 | γ | 9 | 139 | ◯ | X |
| Comp. Ex. 2 | 43 | 0.77 | θ | 3.5 | 72 | ◯ | X |
| Comp. Ex. 3 | — | — | γ | 2.4 | 153 | ◯ | Δ |
| Comp. Ex. 4 | −18 | 0.48 | γ | 2.4 | 153 | X | Δ |
| Comp. Ex. 5 | 70 | 0.61 | γ | 2.4 | 153 | ◯ | X |
| Comp. Ex. 6 | 6 | Anionic | — | — | — | Δ | Δ |

As can be seen from Table 1, in the inkjet recording paper of this invention according to Examples 1-4, good results were obtained for operatability, gloss and printing suitability. On the other hand, in Comparative Example 1 using alumina having an average particle diameter exceeding 8 μm, Comparative Example 2 using θ-alumina, Comparative Example 3 wherein a urethane resin was not blended with the recording layer, Comparative Examples 4 and 5 wherein the glass transition temperature of the urethane resin exceeded the range of the present invention, and Comparative Example 6 wherein an anionic urethane resin was blended and γ-alumina was not used, the image clarity is less than 20% in all cases, and a gloss comparable to that of a silver halide photograph could not be obtained.

### Industrial Application

The inkjet recording medium of this invention not only has a gloss comparable to that of a silver halide photograph, but it can also be produced by a continuous process during manufacture and can be provided at an economical cost, so it has considerable industrial significance.

1. An inkjet recording medium comprising a recording layer formed by coating a coating solution containing alumina, a resin emulsion and polyvinyl alcohol on a support having air permeability, wherein said alumina is y-alumina having an average particle diameter of 8 μm or less, said resin emulsion is a urethane resin emulsion having a glass transition temperature of 10° C.-50° C., and the image clarity of the surface of said recording layer is 20% or more.

2. The inkjet recording medium according to claim 1, wherein the cationic degree of said urethane resin emulsion is 0.6 or more.

3. The inkjet recording medium according to claim 1, wherein said urethane resin emulsion is an emulsion whereof the film has a contact angle of 50° or less relative to water.

4. The inkjet recording medium according to claim 1, wherein said urethane resin emulsion is a polyester type cationic urethane resin emulsion.

5. The inkjet recording medium according to claim 1, wherein the average particle diameter of said y-alumina is 1.0 μm-4.0 μm.

6. The inkjet recording medium according to claim 1, wherein the particle size distribution range of said y-alumina is 0.4-12 μm.

7. The inkjet recording medium according to claim 1, wherein said recording layer is a glossy layer formed by applying a treatment solution having the action of solidifying said polyvinyl alcohol in said coating layer, to the wet coating layer after coating, pressing said coating layer onto the mirror surface of a heated drum while said coating layer is still wet, and drying.
